(19) United States
(12) Patent Application Publication
(10) Pub. No.: US 2017/0273150 A1
(43) Pub. Date: Sep. 21, 2017

(54) DYNAMIC BLEED SYSTEM AND METHOD FOR DYNAMIC LOADING OF A DIMMER USING EVENT DRIVEN ARCHITECTURE

(71) Applicant: GLOBALFOUNDRIES INC., Grand Cayman (KY)

(72) Inventors: Rajesh SWAMINATHAN, Bangalore (IN); Somnath SAMANTHA, Bangalore (IN); Sumon K BOSE, Bangalore (IN); Abhisek KHARE, Bangalore (IN); Hrishikesh BHAGWAT, Bangalore (IN); Ramesh G KARPUR, Bangalore (IN); Krishnadas BHAGWAT, Bangalore (IN)

(21) Appl. No.: 15/531,459

(22) PCT Filed: Nov. 29, 2015
(86) PCT No.: PCT/IB15/59191

§ 371 Date: May 29, 2017

(30) Foreign Application Priority Data
Nov. 29, 2014 (IN) 5989/CHE/2014

(51) Int. Cl. H05B 33/08; G09G 3/34; G02F 1/1335; G09G 3/36

(52) U.S. Cl. CPC H05B 33/0809; H05B 33/0845; G09G 3/36; G09G 3/3426; G09G 3/3406; G02F 1/133606

(57) ABSTRACT

The present invention discloses a dynamic bleed system and method for dynamic loading of a dimmer using event driven architecture for LED applications. An integrated event driven LED driver architecture is used to perform dynamic loading (bleed) of triac dimmer to effectively operate in low power LED applications. The bleeder circuit dynamically loads the dimmer when instantaneous cycle by cycle power falls below a specified value and shuts the bleed path when the power is above a specified value. This threshold is programmable with hysteresis and the loading pattern is programmable as well.

### TECHNICAL FIELD OF THE INVENTION

The present invention relates to a system to dynamically load the dimmer based on the requirement to avoid the LED to misfire/flicker in LED circuits. More particularly, the present invention relates to a method for dynamic loading of the dimmer using event driven architecture for LED applications.

### BACKGROUND OF THE INVENTION

A Light-Emitting Diode (LED) is a semiconductor diode which glows when a voltage is applied. LED technology is broadly used in today's electronic apparatus. LED technology also has developed in today's scenarios, where LED is not only used as an indicator in electronic apparatus, but is used as displays as well as lighting. Due to high energy efficiency, high reliability, long life time, smaller size and characteristics that ensures the adjustment of light intensity, the LEDs are employed in many applications such as aviation lighting, digital microscopes, automotive lighting, backlighting, advertising, general lighting, and traffic signals etc.

In a typical single stage LED driver topologies, the power path current flows through the phase cut, such as triac, dimmer. In conventional systems, a triac dimmer is used to dim LED by shutting the power supply (phase cut dimmers). Triac dimmers were initially designed to operate with resistive loads such as incandescent light sources, when these sources were replaced by efficient LED sources, the overall electrical power consumption reduced significantly to support the same light lumens output.

The triac dimmers are Silicon Controlled Rectifiers (SCR) and require triggering currents and holding currents. These currents are of high value and worked well with high power incandescent load. When LEDs operate at low electrical power regime, these triacs are not adequately loaded electrically and result in misfiring (on/off chatter) which in return results in light flicker.

Various types of conventional systems that use bleeder circuits for dimming light emitting diodes are known in the prior art. The U.S. Pat. No. 7,102,902 discloses about the dimmer circuit for LED. The AC output from a source is rectified and applied to a resistor/Zener diode circuit connection which determines the magnitude of the rectified voltage applied via a circuit to a first MOSFET device. The inverted output of the first MOSFET device is applied to the gate electrode of a second MOSFET device in a manner such that the second MOSFET device is ON even when the AC output passes through zero. The output of the second MOSFET device is connected to a resistor which determines the magnitude of the load applied to the dimmer.

The U.S. Pat. No. 8,896,231 discloses the systems and methods of applying bleed circuits in LED lamps. A bleed circuit is applied to a transformer based on a bleed-on time and a bleed-off time determined by monitoring an output voltage waveform of the transformer.

However, in the claimed systems and methods the dimmer is not loaded as per the requirement. Typically, in the current systems the bleed currents do not have an inverse dependence to system power level consumption to optimize system efficiency and reliable dimmer operation.

Typically, the conventional systems load the dimmer electrically with a shunt load (increase currents though dimmer) at the cost of efficiency but negates the LED power saving use fullness.

Hence, there is need for a dynamic bleed system and method for dynamic loading the dimmer to effectively operate in low power LED applications. Further, the method loads and shuts down the dimmers as and when required.

### SUMMARY OF THE INVENTION

The present invention overcomes the drawbacks in the prior art and provides a dynamic bleed system and method for dynamic loading of a dimmer using event driven architecture for LED applications. The system comprises of an analog digital convertor module for converting the signal from analog to digital signal. A digital analog convertor module is used for converting the signal from digital to analog signal. An event based module is used to receive the analog and digital signals. The event based module is configured to perform dynamic bleeding of the dimmer. An average is used to supply a cycle by cycle input and a firmware module is used to generate the response for the bleeding of dimmer dynamically, wherein the firmware module comprises commands for operating the analog and digital signals for LED applications.

In a preferred embodiment of the invention, the system determines the cycle by cycle power without additional external components.

In a preferred embodiment of the invention, wherein the system further comprises at least one switch for the switching operation, wherein the switch may be any of the electronic switch but not limited to a transistor and a MOSFET.

In a preferred embodiment of the invention, the system is programmable.

In a preferred embodiment of the invention, the system modulates the drive to an external switch and translates to current levels through a simple degenerated resistor network.

In a preferred embodiment of the invention, the drive to external switch has multiple levels in voltage/current domain for different cases such as drive MOSFET/bipolar device.

In a preferred embodiment of the invention, the system is turned ON and OFF in a stair case pattern to reduce the surge in input currents, wherein the stair case pattern reduces the total harmonic distortions by smoothening out bleed currents at lower LED currents.

According to another embodiment of the invention, the invention provides a method for dynamic loading of a dimmer using event driven architecture for LED applications. In most preferred embodiment, the method includes the step of turning ON the bleeder circuit upon sensing the line voltage. Then, loading the dimmer dynamically using a bleeder circuit upon sensing the instantaneous cycle by cycle fall of power below a specified value and turning OFF the bleed circuit upon sensing the power above the specified value.

In a preferred embodiment of the invention, the method further comprises the step of determining instantaneous peak power through an internal digital analog convertor setting and modulating the bleed system accordingly using signal obtained from the digital analog convertor.

In a preferred embodiment of the invention, the method uses a programmable hysteresis to turn ON/OFF the dimmer, wherein the hysteris level is translated to DAC level for defining the plurality of levels.

In a preferred embodiment of the invention, the method turns the bleed system ON and OFF based on the instantaneous cycle by cycle power limit.

In a preferred embodiment of the invention, the method turns ON the bleed system based on instantaneous line voltage level/instantaneous cycle by cycle power.

In a preferred embodiment of the invention, the method turns ON the bleed system based on the instantaneous line voltage level to allow universal compatibility of leading and trailing edge dimmers.

The present invention has been designed to operate with limited external components at the cost of space and price. The architecture is intelligent to determine the cycle by cycle power without additional external components which results in facilitating a smart bleed system. The invented system is designed to turn ON and OFF the bleed system based on instantaneous cycle by cycle power limit, wherein the bleed system is turned ON based on instantaneous line voltage level or instantaneous cycle by cycle power. The bleed circuitry can be turned ON and OFF in a stair case pattern to reduce the surge in input currents and there by easing EMC filter design, wherein the stair case bleed profile helps in reducing Total Harmonic Distortion (THD) by smoothening out bleed currents during low LED currents.

The present invention provides a system and method which is simple, time saving, resource efficient, and cost effective. The invention may be used in variety of applications such as indicator lamps and in different types of lighting environments which uses LED's for lighting.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram of a system for dynamic loading of a dimmer using event driven architecture for LED applications, according to one embodiment of the invention.

FIG. 2 illustrates a non-isolated system for dynamic loading of a dimmer using event driven architecture for LED applications, according to one embodiment of the invention.

FIG. 3 illustrates the waveforms of anon-isolated system for dynamic loading of a dimmer using event driven architecture for LED applications, according to one embodiment of the invention.

FIG. 4 illustrates the waveforms pertaining to the functionality of bleed, according to one embodiment of the invention.

FIG. 5 illustrates the waveforms pertaining to bleed for Electromagnetic Capability (EMC), according to one embodiment of the invention.

FIG. 6 illustrates the circuit pertaining to simple functionality of bleed, according to one embodiment of the invention.

FIG. 7 illustrates the method flow for dynamic loading of a dimmer using event driven architecture for LED applications, according to one embodiment of the invention.

### DETAILED DESCRIPTION OF THE INVENTION

Reference will now be made in detail to the description of the present subject matter, one or more examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

The present invention discloses a dynamic bleed system and method for dynamic loading of a dimmer using event driven architecture for LED applications. The system comprises of an analog digital convertor module for converting the signal from analog to digital signal. A digital analog convertor module is used for converting the signal from digital to analog signal. An event based module is used to receive the analog and digital signals. The event based module is configured to perform dynamic bleeding of the dimmer. A firmware module is used to generate the response for the bleeding of dimmer dynamically, wherein the firmware module comprises the commands for operating the analog and digital signals for LED applications.

The present invention has been designed to realize through limited external components at the cost of space and price. The architecture is intelligent to determine the cycle by cycle power without additional external components which results in facilitating a smart bleed system. The invented system is designed to turn ON and OFF the bleed system based on instantaneous cycle by cycle power limit, wherein the bleed system is turned ON based on instantaneous line voltage level or instantaneous cycle by cycle power. The bleed circuitry can be turned ON and OFF in a stair case pattern to reduce the surge in input currents, thereby easing EMC filter design, wherein the stair case bleed profile helps in reducing Total Harmonic Distortion (THD) by smoothening out bleed currents during low LED currents.

The present invention provides a system and method which is simple, time saving, resource efficient, and cost effective. The invention may be used in variety of applications as indicator lamps and in different types of lighting environments which uses LED's.

FIG. 1 illustrates a block diagram of a system for dynamic loading of a dimmer using event driven architecture for LED applications, according to one embodiment of the invention. In the preferred embodiment, the system comprises of an analog digital convertor module (101) for converting the signal from analog to digital signal. A digital analog convertor module (102) is used for converting the signal from digital to analog signal. An event based module (104) is used to receive the analog and digital signals. The event based module is configured to perform dynamic bleeding of the dimmer. An average (103) is used to supply a cycle by cycle input. A firmware module (106) is used to generate the response for the bleeding of dimmer dynamically, wherein the firmware module comprises commands for operating the analog and digital signals for LED applications. The bleeder circuit (105) dynamically loads the dimmer when instantaneous cycle by cycle power falls below a specified value and shuts the bleed path when the power is above a specified value.

In the preferred embodiment, the system (100) further is configured to detect the dimmer in offline LED circuits in order to determine the cycle by cycle power loading on AC Line and in turn takes the decision to turn ON bleed, wherein if the dimmer is not detected then bleed is not turned ON and thereby the efficiency is improved.

FIG. 2 illustrates anon-isolated system for dynamic loading of a dimmer using event driven architecture for LED applications, according to one embodiment of the invention. In the preferred embodiment, the primary side and the secondary side of the transformer are not isolated i.e. they are connected together. Here, the DAC module (201) establishes the desired set voltage by regulating the primary and secondary peak voltages of the analog signal. The controlled primary and secondary side currents are allowed to flow through a sense resistor (202) to generate a voltage, wherein the generated voltage is in the form of saw tooth waveform. The saw tooth waveform enables the user(s) to determine and calculate the turn ON time and turn OFF time of the switch to turn ON and OFF the bleeding circuit.

FIG. 3 illustrates the waveforms of anon-isolated system for dynamic loading of a dimmer using event driven architecture for LED applications, according to one embodiment of the invention. In the preferred embodiment, the primary and secondary side currents for each cycle are calculated.

The reference voltage is equal to the peak of the sense voltage. Therefore, the peak LED current is equal to the reference voltage divided by the sensed resistance. The average is considered to be the half of the calculated peak LED current for every cycle.

Vref/Rsense=Sense (peak)/Rsense

Hence, Iled (peak)=Vref/Rsense

Average=Tied (peak)/2 (Every cycle)

FIG. 4 illustrates the waveforms pertaining to the functionality of bleed, according to one embodiment of the invention. The figure represents that the zero line detector is equal to 1 when the line voltage is greater than LED voltage. The output of the DAC is represented in the figure. For the bleeding circuit, the bleed is equal to 1 when zero line detector is equal to 1.

Zero Line Detector=1 if LINE<LED Voltage

BLEED=1 when ZLD=1

FIG. 5 illustrates the waveforms pertaining to bleed for Electromagnetic Capability (EMC), according to one embodiment of the invention. The figure represents the bleed current step size and duration programmable for EMC benefit.

The bleed circuitry can be turned ON and OFF in a stair case pattern to reduce the surge in input currents and there by easing EMC filter design, wherein the stair case bleed profile helps in reducing Total Harmonic Distortion (THD) by smoothening out bleed currents during low LED currents.

FIG. 6 illustrates the circuit pertaining to simple functionality of bleed, according to one embodiment of the invention. In the preferred embodiment, the firmware module generates the response for the bleeding of dimmer dynamically. The firmware module comprises commands for operating the analog and digital signals for LED applications. The base voltage is calculated in the firmware module and supplied to the bleeder circuit for dynamically loading the dimmer when instantaneous cycle by cycle power falls below a specified value and shuts the bleed path when the power is above a specified value.

The firmware is configured to the system to set the turn ON and OFF points to increase noise immunity and prevent misfiring in order to build hysteresis levels.

FIG. 7 illustrates the method flow for dynamic loading of a dimmer using event driven architecture for LED applications, according to one embodiment of the invention. The method comprises the steps of turning ON the bleeder circuit upon sensing the line voltage (701). Then, loading the dimmer dynamically using a bleeder circuit upon sensing the instantaneous cycle by cycle fall of power below a specified value (702). Further, turning OFF the bleed circuit upon sensing the power above the specified value (703).

In the preferred embodiment, the method also determines the instantaneous peak power through an internal digital analog convertor setting and modulates the bleed system accordingly using signal obtained from the digital analog convertor, wherein the method uses a programmable hysteresis to turn ON/OFF the dimmer, wherein the hysteris level is translated to DAC level for defining the plurality of levels.

The present invention provides a system and method which is simple, time saving, resource efficient, and cost effective. The invention may be used in variety of applications such as indicator lamps and in different types of lighting environments which uses LED's for lighting.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

We claim:

1) A dynamic bleed system for dynamic loading of a dimmer using event driven architecture for LED applications, the system comprises of:
a. an analog digital convertor module (101) for converting the signal from analog to digital signal;
b. a digital analog convertor module (102) for converting the signal from digital to analog signal;
c. an event based module (104)to receive the analog and digital signals;
d. the event based module configured to perform dynamic bleeding of the dimmer;
e. an averager (103) to supply a cycle by cycle input; and
f. a firmware module (106) to generate the response for the bleeding of dimmer dynamically, wherein the firmware module comprises commands for operating the analog and digital signals for LED applications.

2) The system as claimed in claim 1, wherein said system determines the cycle by cycle power without additional external components.

3) The system as claimed in claim 1, wherein the system further comprises at least one switch for the switching operation, wherein the switch may be any of the electronic switch but not limited to a transistor and a MOSFET.

4) The system as claimed in claim 1, wherein said system modulates the drive to an external switch and translates to current levels through a simple degenerated resistor network, wherein said system is programmable.

5) The system as claimed in claim 4, wherein said drive to external switch has multiple levels in voltage/current domain for one or more cases such as drive MOSFET/bipolar device.

6) The system as claimed in claim 1, wherein said system is turned ON and OFF in a stair case pattern to reduce the surge in input currents.

7) The system as claimed in claim 6, wherein said stair case pattern reduces total harmonic distortions by smoothening out bleed currents at lower LED currents.

8) The system as claimed in claim 1, wherein said system is further configured to detect the dimmer in offline LED circuits in order to determine the cycle by cycle power loading on AC Line and in turn takes the decision to turn ON bleed.

9) A method for dynamic loading of a dimmer using event driven architecture for LED applications, the method comprising:
a) turning ON the bleeder circuit upon sensing the line voltage;
b) loading the dimmer dynamically using a bleeder circuit upon sensing the instantaneous cycle by cycle fall of power below a specified value; and
c) turning OFF the bleed circuit upon sensing the power above the specified value.

10) The method as claimed in claim 9, wherein said method further comprises the steps of:
a) determining instantaneous peak power through an internal digital analog convertor setting and modulating the bleed system accordingly using signal obtained from the digital analog convertor.

11) The method as claimed in claim 9, wherein said method uses a programmable hysteresis to turn ON/OFF the dimmer, wherein the hysteris level is translated to DAC level for defining the plurality of levels.

12) The method as claimed in claim 9, wherein said method turns the bleed system ON and OFF based on the instantaneous cycle by cycle power limit, wherein said method turns ON the bleed system based on instantaneous line voltage level/instantaneous cycle by cycle power and allows the universal compatibility of leading and trailing edge dimmers.
